(19) United States
(12) Patent Application Publication
(10) Pub. No.: US 2007/0219673 A1
(43) Pub. Date: Sep. 20, 2007

(54) Master chassis automatic selection system and method

(75) Inventor: Tsung-Pin Wang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/378,110

(22) Filed: Mar. 17, 2006

(51) Int. Cl. G05D 1/00

(52) U.S. Cl. 701/1

(57) ABSTRACT

A master chassis automatic selection system and the method thereof, wherein one of a plurality of chassis connected to an Intelligent Chassis Management Bus is dynamically selected as a master chassis, to enable the dominant master chassis to control the other chassis connected to the Intelligent Chassis Management Bus, and one of the chassis connected to the Intelligent Chassis Management Bus is selected as a master chassis in the light of the priority given to the Intelligent Chassis Management Bus Addresses of individual chassis. Hence, the present invention has advantages of dynamic selection of a master chassis, acquiring status messages about the other slave chassis by means of the selected master chassis, real-time efficient monitoring of the other slave chassis by users through the master chassis, reduction in monitoring time, and enhancement of work efficiency.

### FIELD OF THE INVENTION

The present invention relates to a master chassis automatic selection system and the method thereof, and more particularly, to a system of dynamically selecting one of a plurality of chassis connected to an Intelligent Chassis Management Bus (ICMB) as a master chassis and the method thereof.

### DESCRIPTION OF THE PRIOR ART

With the development and advancement of the Internet technology, the use of servers is becoming wider and more intensive. Efficient management of geographically dispersed server chassis and large machine rooms is always a time-consuming, laborious task, as it deals with numerous, various server chassis and involves inspecting chassis one by one on the site to differentiate well-functioning chassis from malfunctioning chassis; after the emergence of the Internet, inspection is carried out through remote management interfaces supplied by individual manufacturers, but its shortcomings are, namely a lack of timeliness, being impossible to identify the cause of server failure, considerable system resources required. In the past, a method for efficient management of the numerous, diverse and even cross-region systems was unavailable.

Designed to address the aforesaid issue is an Intelligent Platform Management Interface (IPMI) that provides a cross-platform standard interface for real-time monitoring of a server system, by monitoring the Internet status (discovering all network nodes, identifying the online status of the network nodes, identifying network conditions, and monitoring information of the network nodes, such as IP, domain names and Internet flow), static information of a server system (the CPU, RAM, hard disk drive, CD-ROM drive, network interface card, display card, and operating system), and dynamic information of the server system (temperature, voltage and fan rotation speed of devices like motherboards, CPU and cooling kits, as well as system resources information, such as CPU usage, memory usage, and hard disk I/O flow). Once abnormality happens to the aforesaid monitored parameters, says, exceeding a critical threshold, the monitoring software will give various warnings (message dialog boxes, emails, warning tones and short messages) and record the warning events in a log so that an administrator can perform analysis and diagnosis in accordance with the warning log. The Intelligent Chassis Management Bus (ICMB) conveniently links up server chassis located in the same region or in different regions. The administrator accesses a remote server through the Intelligent Chassis Management Bus, analyzes and confirms the cause of failure by obtaining data in an event log and sensors, and achieves server restore through remote operation.

However, the aforesaid plurality of chassis linked up by the Intelligent Chassis Management Bus do not have a master chassis that controls the rest of the chassis, thus users (for example, system administrators) who want to gain an insight into the operating conditions of individual chassis have to take much time logging in the server chassis one by one in order to do so and monitor the server chassis in the light of apprehended messages; as a result, users are unable to monitor the server chassis in a real-time efficient manner.

Providing a master chassis automatic selection system and the method thereof for server chassis to overcome disadvantages of the prior art, such as inefficient monitoring and lengthy monitoring, has become an important issue to be urgently addressed by the industry.

### SUMMARY OF THE INVENTION

Accordingly, it is a primary objective of the present invention to solve the problems of the prior art by providing a master chassis automatic selection system wherein one of a plurality of chassis connected to an Intelligent Chassis Management Bus (ICMB) is dynamically selected as a master chassis and the method thereof.

Another objective of the present invention is to provide a master chassis automatic selection system and the method thereof, in order to dynamically select one of the chassis connected to the ICMB as a master chassis, and enable the master chassis to control other chassis in a real-time efficient manner, with a view to saving user's time and enhancing monitoring efficiency.

In order to achieve the above objectives, the present invention provides a master chassis automatic selection system and the method thereof, wherein one of a plurality of chassis connected to an Intelligent Chassis Management Bus (ICMB) is dynamically selected as a master chassis. The master chassis automatic selection system of the present invention comprises a plurality of connection modules which are disposed in the chassis and configured to connect the chassis to the ICMB via the connection modules, a detection module configured to detect and determine whether a new chassis is connected to the ICMB, an address module intended to provide an Intelligent Chassis Management Bus Address (ICMB Address) for the newly connected chassis whenever the detection module detects the new chassis being connected to the ICMB, a scan module configured to scan other chassis previously connected to the ICMB and determine whether a master chassis is present, and a control module configured to dynamically select one of the chassis connected to the ICMB as a master chassis in the light of a scanning result of the scan module so that the master chassis can control the other chassis connected to the ICMB.

If the scan performed on the other chassis by the scan module does not reveal any master chassis, the control module selects the newly connected chassis as a master chassis to control the other chassis connected to the ICMB. If the scan performed on the other chassis by the scan module reveals a master chassis, the control module chooses a master chassis, between the newly connected chassis and the master chassis in the light of the priority given to them, to control the other chassis connected to the ICMB.

The control module further comprises a comparison unit configured to compare the priority given to the newly connected chassis with that given to the master chassis whenever the scan performed on the other chassis by the scan module reveals a master chassis, and a selection unit intended to select a master chassis in the light of a comparison result of the comparison unit; if the newly connected chassis has priority over the master chassis, the newly connected chassis is selected as a master chassis, otherwise the previously selected master chassis continues to control the other chassis connected to the ICMB.

The master chassis automatic selection method of the present invention applies to a master chassis automatic selection system. The master chassis automatic selection system is configured to dynamically select one of a plurality of chassis connected to an Intelligent Chassis Management Bus (ICMB) as a master chassis. The master chassis automatic selection method comprises the following steps: (1) having the master chassis automatic selection system detect and determine whether a new chassis is connected to the ICMB, in case of an answer being affirmative, proceeding to Step (2), otherwise executing Step (1) again; (2) having the master chassis automatic selection system provide an ICMB Address for the chassis newly connected to the ICMB, and the newly connected chassis is set to slave state; (3) having the master chassis automatic selection system scan the other chassis connected to the ICMB; then proceeding to Step (4), if the scan performed on the other chassis by the master chassis automatic selection system does not reveal any master chassis at master state; and proceeding to Step (5), if the scan performed on the other chassis by the master chassis automatic selection system reveals a master chassis at master state; (4) having the master chassis automatic selection system select the newly connected chassis as a master chassis to control the other chassis connected to the ICMB, so as to end the current operation of master chassis selection and then return to Step (1); and (5) having the master chassis automatic selection system compare the newly connected chassis with the master chassis to determine whether the former has priority over the latter; in case of an answer in the affirmative, returning to Step (4), otherwise ending the current operation of master chassis selection and thereby making the master chassis continue to control the other chassis connected to the ICMB, and returning to Step (1).

As opposed to the prior art, the present invention provides a master chassis automatic selection system and the method thereof, wherein, owing to the operation of the scan module and the control module, one of a plurality of chassis connected to an Intelligent Chassis Management Bus is dynamically selected as a master chassis; as a result, the master chassis can collect messages about the operating status of the other chassis connected to the ICMB, and users can gain access to the messages about the other chassis via the master chassis and monitor the other chassis in a real-time efficient manner.

### BRIEF DESCRIPTION OF THE DRAWINGS

FIG. 1 is a block diagram showing the basic of a master chassis automatic selection system according to the present invention.

FIG. 2 is a flowchart showing the steps in a master chassis automatic selection method.

### DETAILED DESCRIPTION OF THE PREFERRED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified or changed based on different viewpoints and applications yet still within the scope of the present invention.

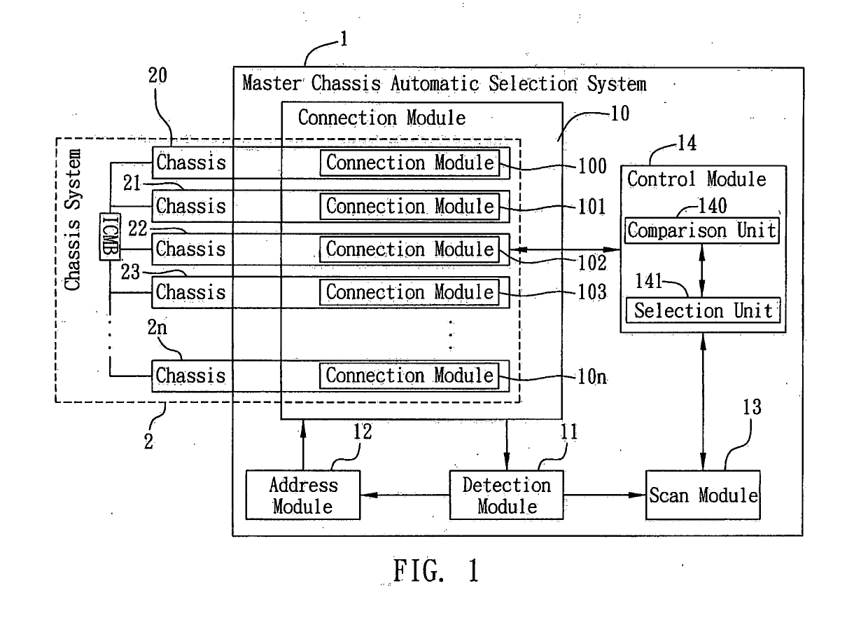

Referring to FIG. 1, which is a block diagram showing the basic of a master chassis automatic selection system 1 according to the present invention. As showed in the figure, the system 1 is configured to dynamically select one of a plurality of chassis 2 (20, 21, 22, 23 . . . 2n) connected to an Intelligent Chassis Management Bus (ICMB) 3 as a master chassis. As disclosed by the present invention, the chassis system 2 is a general chassis with a base management controller (BMC) (i.e. a server) or without any BMC (i.e. a peripheral chassis). The master chassis automatic selection system 1 comprises a plurality of connection modules 10 (100, 101, 102, 103 . . . 10n), a detection module 11, an address module 12, a scan module 13, and a control module 14. The master chassis automatic selection system 1 is, in conjunction with the drawings, described in detail as follows.

The connection modules 10 (100, 101, 102, 103 . . . 10n) are disposed in the Intelligent Chassis Management Bus (ICMB) 3 via the corresponding connection module 10. As disclosed by the present invention, the connection module 10 serves as an ICMB bridge, and the chassis are connected to the Intelligent Chassis Management Bus 3 via the corresponding bridges.

The detection module 11 detects and determines whether a new chassis 2 is connected to the Intelligent Chassis Management Bus 3. The address module 12 provides an Intelligent Chassis Management Bus Address (ICMB Address) for a newly connected chassis whenever the detection module 11 detects the newly connected chassis. As disclosed by the present invention, the address module 12 automatically searches for an address different from the ICMB addresses of the chassis previously connected to the Intelligent Chassis Management Bus and assigns the found address to the newly connected chassis; in other words, the address module 12 provides the connection module 10 (the bridge) of the newly connected chassis with a sole ICMB Address, to enable the newly connected chassis to be connected to the Intelligent Chassis Management Bus 3 via the connection module 10, and to facilitate communication between the newly connected chassis and the other chassis by the Intelligent Chassis Management Bus 3. The Intelligent Chassis Management Bus 3 has an address conflict detection mechanism for ensuring that every chassis connected to the Intelligent Chassis Management Bus 3 will be assigned one and only one ICMB Address; the above-mentioned is not about a new art, nor is it a characteristic of the present invention, thus no wordy description is given herein.

The scan module 13 scans the other chassis previously connected to the Intelligent Chassis Management Bus 3 and determines whether a master chassis is present, that is, whether any chassis is at master state, and then the scan module 13 produces a scan result to which the control module 14 refers when performing the ensuing master chassis selection.

The control module 14 refers to the scan result and selects one of the chassis (including the newly connected chassis and the chassis previously connected to the Intelligent Chassis Management Bus 3) connected to the Intelligent Chassis Management Bus 3 as a master chassis, and the master chassis controls the other chassis connected to the Intelligent Chassis Management Bus 3. More particularly, if the scan performed on the other chassis by the scan module 13 does not reveal any master chassis, the control module 14 refers to the scan result and selects the newly connected chassis as a master chassis to control the chassis previously connected to the Intelligent Chassis Management Bus 3. If the scan performed on the other chassis by the scan module 13 reveals a master chassis, a master chassis is chosen between the newly connected chassis and the current master chassis, depending on priority, wherein the priority relates to the values of the ICMB Addresses of individual chassis connected to the Intelligent Chassis Management Bus 3, and the rule for the priority may be set beforehand by users if necessary, for example, giving priority to a chassis with a large (or small) ICMB Address value.

The control module 14 further comprises a comparison unit 140 and a selection unit 141. If the scan performed on the other chassis by the scan module 13 reveals a master chassis, then the comparison unit 140 compares the newly connected chassis with the master chassis in terms of priority and produces an output comparison result. The selection unit 141 selects a master chassis in accordance with the comparison result; if the newly connected chassis has priority over the master chassis, then the newly connected chassis is selected as a master chassis, otherwise the current selection of master chassis is ended and the prior master chassis controls the other chassis connected to the Intelligent Chassis Management Bus 3.

To further highlight the advantages and features of the present invention, the master chassis automatic selection system 1 of the present invention is further described in detail as follows. Not to be construed as to limit the scope of application of the present invention, description is herein given by way of example, wherein chassis 20, 21, 22 (chassis 20, 21, 22 are connected to the Intelligent Chassis Management Bus 3 via the connection modules 100, 101, 102 respectively) are connected to the Intelligent Chassis Management Bus 3, and the master chassis automatic selection system 1 of the present invention selects the chassis 20 as a master chassis (i.e. setting the chassis 20 to master state) and the remaining chassis 21, 22 as a slave chassis (i.e. setting the chassis 21, 22 to slave state).

If the detection module 11 detects a new chassis 23 being connected to the Intelligent Chassis Management Bus 3 via the connection module 103, then the address module 12 assigns the chassis 23 a sole ICMB Address and temporarily sets the chassis 23 to slave state (i.e. the chassis 23 functions as a slave chassis connected to the Intelligent Chassis Management Bus 3); afterward, the scan module 13 scans the chassis 20, 21, 22 previously connected to the Intelligent Chassis Management Bus 3; if the scan reveals that the chassis 20 is at master state (i.e. a master chassis), then the comparison unit 140 compares the chassis 23 with the chassis 20 in terms of ICMB address value; if the ICMB address value of the chassis 23 is greater (or less) than that of the chassis 20, then the selection unit 141 selects the chassis 23 as a master chassis (i.e. switching from a slave state to a master state, as far as the chassis 23 is concerned), and the corresponding chassis 20 is turned into a slave chassis (i.e. switching from a master state to a slave state, as far as the chassis 20 is concerned), and in consequence the chassis 23 gains dominance and thereby controls the other chassis 20, 21, 22 previously connected to the Intelligent Chassis Management Bus 3. In the event that the ICMB Address of the chassis 23 is not greater (or not less) than that of the chassis 20, then the selection unit 141 continues to treat the previously selected chassis 20 as a master chassis and the corresponding chassis 23 as a slave chassis connected to the Intelligent Chassis Management Bus 3, thus the chassis 20 continues to control the other chassis 21, 22, 23 connected to the Intelligent Chassis Management Bus 3.

Afterward, the other slave chassis at slave state, such as the chassis 21, 22, 23, are monitored in a real-time efficient manner by means of a chassis at master state, such as the chassis 20. For instance, the chassis 20 receives from the other slave chassis 21, 22, 23 messages about the operating conditions thereof through the Intelligent Chassis Management Bus 3, to enable local users to log in the chassis 20 and gain an insight into the operating conditions of the other chassis in a real-time efficient manner. In addition, as disclosed by the present invention, a chassis at master state may also send a remote monitoring device any received messages about the status of a slave chassis along with any status messages about the master chassis through a network, to enable remote users to perform long-rang monitoring of the chassis through the remote monitoring device and ensure that individual chassis will function well.

Besides, as disclosed by the present invention, the Intelligent Chassis Management Bus 3, to which a new chassis is connected, may dynamically select one of the chassis as a master chassis.

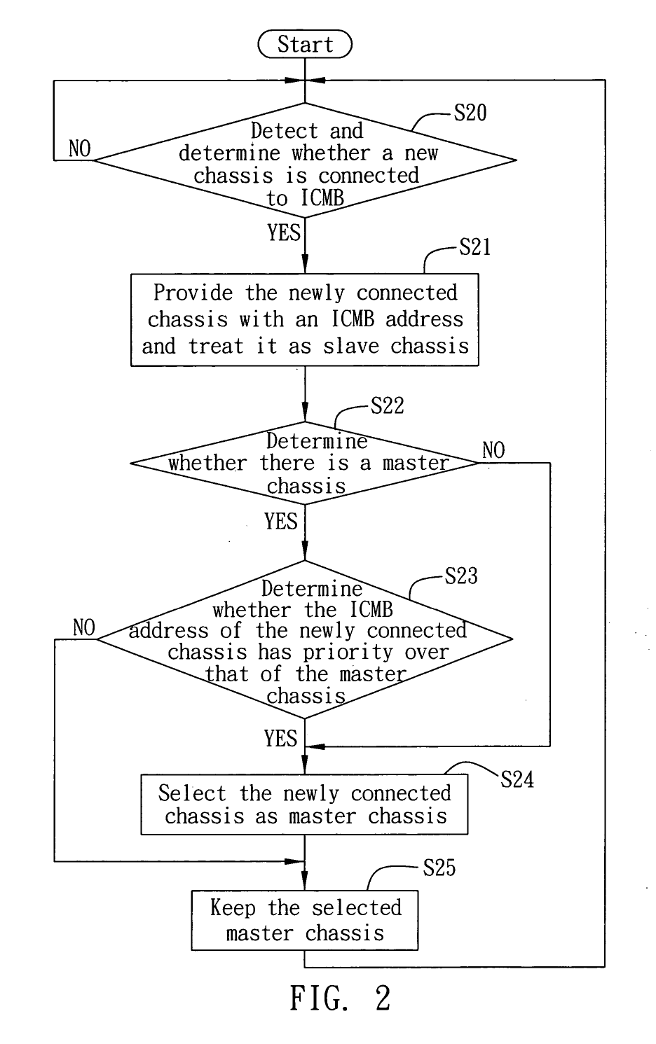

FIG. 2 shows a flowchart about the execution of the master chassis automatic selection method of the present invention by means of the master chassis automatic selection system 1 of the present invention; in the present embodiment, description is given in conjunction with an example wherein the chassis 20, 21, 22 have already been connected to the Intelligent Chassis Management Bus 3, though it should not be construed as to limit the scope of the present invention in any way.

The master chassis automatic selection method comprises the following implementation steps:

In Step S20, the detection module 11 detects and determines whether a new chassis 23 is connected to the Intelligent Chassis Management Bus 3 through the connection module 10; in case of an answer in the affirmative, proceed to Step S21; in case of a negative answer, repeat Step S20.

In Step S21, the address module 12 provides the newly connected chassis 23 with an Intelligent Chassis Management Bus Address (ICMB Address); in other words, the address module 12 provides the bridge of the chassis 23 with a sole ICMB Address, thus the chassis 23 may be connected to the Intelligent Chassis Management Bus 3 through the corresponding bridge, and the chassis 23 may be temporarily set to slave state (i.e. a slave chassis). To be followed by Step S22.

In Step S22, the scan module 22 scans the chassis previously connected to the Intelligent Chassis Management Bus 3 for any chassis set to master state (i.e. whether there is a master chassis); in case of an answer in the affirmative, proceed to Step S23; in case of a negative answer, proceed to Step S24.

In Step S23, the comparison unit 140 compares the newly connected chassis 23 with the chassis set to master state (for example, the chassis 20) and determines whether the former has priority over the latter; in other words, the comparison unit 140 compares the newly connected chassis 23 with the chassis set to master state and determines whether the ICMB address value of the former is greater than that of the latter; in case of an answer in the affirmative, proceed to Step S24; in case of a negative answer, proceed to Step S25.

In Step S24, the selection unit 141 selects the newly connected chassis 23 as a master chassis, that is, switching the newly connected chassis 23 from slave state to master state, to enable the newly connected chassis 23 to become a master chassis and gain control over the previously connected chassis 20, 21, 22. At this point, end the current operation of master chassis selection and return to Step S20.

In Step S25, the current selection operation is ended, and the previously selected chassis remains a master chassis and continues to control the other chassis connected to the Intelligent Chassis Management Bus 3; afterward, the method returns to Step S20.

In short, with the master chassis automatic selection system and the method thereof according to the present invention, one of a plurality of chassis connected to an Intelligent Chassis Management Bus is dynamically selected as a master chassis, to enable the dominant master chassis to control the other chassis connected to the Intelligent Chassis Management Bus. Hence, the present invention has the following advantages: dynamic selection of a master chassis, acquiring status messages about the other slave chassis by means of the master chassis, real-time efficient monitoring of the other slave chassis by means of the master chassis, reduction in monitoring time, and enhancement of work efficiency.

Besides, the master chassis of the present invention sends status messages about the other slave chassis to a remote monitoring device through a network, to enable users to perform long-rang monitoring on the plurality of chassis connected to the Intelligent Chassis Management Bus and ensure that individual chassis will function well.

The embodiments described above are only to illustrate principles and features of the present invention; it should not be construed as to limit the scope of the present invention in any way. Any person skilled in the art may modify or change the aforesaid embodiments without departing from the spirit and principle in the disclosure of the present invention. Hence, the scope of the protection for the present invention should fall within the scope of the appended claims.

What is claimed is:

1. A master chassis automatic selection system for dynamically selecting one of a plurality of chassis connected to an Intelligent Chassis Management Bus (ICMB) as a master chassis, comprising:
a plurality of connection modules which are disposed in said chassis and configured to connect said chassis to said ICMB via said connection modules;
a detection module configured to detect and determine whether a new chassis is connected to said ICMB;
an address module configured to provide an ICMB Address for a newly connected chassis whenever said detection module detects said new chassis being connected to said ICMB;
a scan module configured to scan other chassis previously connected to said ICMB and determine whether a master chassis is present; and
a control module configured to dynamically select one of said chassis connected to said ICMB as a master chassis in light of a scanning result of said scan module so that said master chassis can control said other chassis connected to said ICMB.

2. The master chassis automatic selection system as claimed in claim 1, wherein if the scan performed on the other chassis by said scan module does not reveal any master chassis, then said control module selects the new chassis connected to said ICMB as a master chassis.

3. The master chassis automatic selection system as claimed in claim 1, wherein, if the scan performed on the other chassis by said scan module reveals a master chassis, then said control module chooses a master chassis between the new chassis connected to said ICMB and said master chassis in light of priority given to them.

4. The master chassis automatic selection system as claimed in claim 3, wherein said control module comprises:
a comparison unit configured to compare said newly connected chassis with said master chassis in terms of said priority; and
a selection unit configured to select a master chassis in light of a comparison result of said comparison unit, wherein if said newly connected chassis has said priority over said master chassis, said newly connected chassis is selected as a master chassis, otherwise keep the previously selected master chassis to control the other chassis connected to said ICMB.

5. The master chassis automatic selection system as claimed in claim 3, wherein said priority refers to a difference in ICMB address values of individual chassis connected to said ICMB.

6. The master chassis automatic selection system as claimed in claim 4, wherein said priority refers to a difference in ICMB address values of individual chassis connected to said ICMB.

7. The master chassis automatic selection system as claimed in claim 1, wherein said connection module is a bridge disposed in said chassis and configured to connect said chassis to said ICMB.

8. A master chassis automatic selection method that applies to a master chassis automatic selection system, wherein said master chassis automatic selection system is used to dynamically select one of a plurality of chassis connected to an Intelligent Chassis Management Bus (ICMB) as a master chassis, said master chassis automatic selection method comprising the steps of:
detecting and determining whether there is a newly connected chassis by said master chassis automatic selection system;
if a newly connected chassis is detected, having said master chassis automatic selection system provide said chassis newly connected to said ICMB with an ICMB Address and set said newly connected chassis to slave state;
having said master chassis automatic selection system scan the other chassis connected to said ICMB such that, if the scan performed on the other chassis by said master chassis automatic selection system does not reveal any master chassis at master state, then said master chassis automatic selection system selects said newly connected chassis as a master chassis to control the other chassis connected to said ICMB, and the aforesaid step that involves detecting and determining whether a new chassis is connected to said ICMB is executed; and
if the scan performed on the other chassis by said master chassis automatic selection system reveals a master chassis at master state, having said master chassis automatic selection system compare the newly connected chassis with said master chassis in terms of said priority, so as to select a master chassis from the chassis connected to said ICMB in light of a comparison result, before executing the aforesaid step that involves detecting and determining whether a new chassis is connected to said ICMB.

9. The master chassis automatic selection method as claimed in claim 8, wherein said priority refers to a difference in ICMB address values of individual chassis connected to said ICMB.
